(19) United States
(12) Patent Application Publication
(10) Pub. No.: US 2004/0178980 A1
(43) Pub. Date: Sep. 16, 2004

(54) Liquid crystal display and its driving method

(75) Inventors: Yong-Nien Rao, Hsinchu City (TW); Shih-Tzung Chou, Hsinchu County (TW); Kun Tsung Lin, Taichung City (TW)

Correspondence Address: BACON & THOMAS, PLLC, 625 SLATERS LANE, FOURTH FLOOR, ALEXANDRIA, VA, 22314

(73) Assignee: Sunplus Technology Co., Ltd., Hsin-Chu (TW)

(21) Appl. No.: 10/698,531

(22) Filed: Nov. 3, 2003

(30) Foreign Application Priority Data
Mar. 10, 2003 (TW) 92105117

(51) Int. Cl. G09G 3/36

(52) U.S. Cl. 345/96

(57) ABSTRACT

A liquid crystal display and its driving method utilize a polarity arrangement timing generator to generate signals for polarity-arrangement control. Those signals are output to a polarity arrangement programmable data driver, which accordingly produces a set of signals with aperiodically arranged polarities. Those aperiodic signals are exported to a display panel so that the pixels on the panel are supplied with voltage signals with an aperiodic polarity distribution. Further, picture frames displayed in pre-determined time period have pixel polarity distributions that are mutually complementary; that is, one half of the frames have pixels with polarities exactly opposite to those of the pixels in the other half.

### BACKGROUND OF THE INVENTION

1. Field of the Invention

The present invention relates to a flat panel display, and more particularly to a liquid crystal display (LCD) and its driving method, which can be applied to source drivers or timing controllers of a low-temperature poly-silicon (LTPS) liquid crystal display, or applied to source drivers or timing controller of thin-film transistor (TFT) LCD.

2. Description of Related Art

Following the advances in the electro-optical industry, the flat panel display has successfully taken over the conventional cathode-ray tube (CRT) display. The flat panel display utilizes a variety of technologies, such as LCD, TFT-LCD, or organic light emission display (OLED). The commonly used LCD and TFT-LCD utilize operating voltages to control the arrangement of liquid crystal molecules, which in turn varies the light transmission through these devices.

However, continuously applying operating voltages of the same polarity to a block of liquid crystal for an extended period will cause a permanent deformation therein, which inevitably deteriorates the LCD displaying quality. There are several methods for alternating the polarity of an LCD control voltage, which are summarized as follows. Referring to FIG. 1, a display panel 100 is divided into many frames, for example frames 110, 120, 130 and 140. Any adjacent pair of these frames has opposite polarity distributions; namely, each pixel 111 of the frame 110 has a polarity opposite to the pixel 121 of frame 120 and the pixel 131 of frame, respectively. Furthermore, the each pixel 122 of frame 120 has a polarity opposite to the pixel 112 of frame 110 and the pixel 142 of frame 140, respectively. This method is operated on the basis of frames 110, 120, 130, and 140. When the column signal of the display panel 100 is driven by time-division multiple access (TDMA), it is likely that some special display patterns may cause pixels of one polarity to have a voltage sum largely exceeding the voltage sum of pixels of the other polarity, inducing an effect of “crosstalk”. This effect exhibits a phenomenon that the picture of a region on the panel influences the brightness of nearby regions, which deteriorates the LCD displaying quality.

FIG. 2 illustrates a method of assigning irregular polarity variations along the data-line direction (the vertical direction in the figure) on a display panel 200. The pixel polarities in the row-line direction (the horizontal direction in the figure) are adjacently complementary. Therefore, if the vertical signals are driven by time-division multiple access (TDMA), the voltage sum of pixels of one polarity may largely exceed that of pixels of the other polarity, and thus an effect of “crosstalk” that deteriorates LCD picture quality will be induced.

### SUMMARY OF THE INVENTION

Accordingly, the primary object of the present invention is to provide a liquid crystal display and its driving method capable of reducing the effect of “crosstalk” so as to enhance the image quality.

It is a secondary object of the present invention that the polarity inversion between adjacent pixel blocks of a frame is reduced to achieve an effect of saving electric power.

A liquid crystal display in accordance with the present invention comprises a display panel having a plurality of pixels; a scanning unit connected to the display panel by a plurality of scanning lines so that the scanning unit controls the pixels of the display panel via the scanning lines; a polarity arrangement timing generator (PATG) for generating a plurality of polarity arrangement control (PAC) signals; and a polarity arrangement programmable data driver (PADD) connected to a plurality of data lines and receiving the polarity arrangement control signal so as to output a set of aperiodic polarity order to the data lines so that the polarities of the pixels are distributed aperiodically.

Accordingly, the present invention provides a liquid crystal display driving method for controlling the polarity of a display panel that has a plurality of pixels. The liquid crystal display driving method comprises following steps: a timing generation step for generating a plurality of polarity arrangement control (PAC) signals; a selecting step for outputting a set of aperiodic polarity order based on the polarity arrangement control signals; and a polarity controlling step for sending the set of aperiodic polarity order to the display panel and thereby controlling polarities of the pixels of the display panel such that an aperiodic polarity distribution is exhibited, wherein, when the display panel displays a plurality of frames, a predetermined number of picture frames are displayed in a way that one half of the frames have pixels with polarities exactly opposite to those of the pixels in the other half.

The various objects and advantages of the present invention will be more readily understood from the following detailed description when read in conjunction with the appended drawings.

### BRIEF DESCRIPTION OF THE DRAWINGS

FIG. 1 shows a block-based pixel polarity control mechanism of the prior art;

FIG. 2 shows randomly assigning polarities over pixels along the column direction of the prior art;

FIG. 3 is a diagram showing the structure of a preferred embodiment of the present invention;

FIG. 4 shows the internal structure of a polarity arrangement programmable data driver of a preferred embodiment of the present invention;

FIG. 5 is a flow chart illustrating the operation of a preferred embodiment of the present invention;

FIG. 6 is the first diagram of the pixel polarity distribution of a preferred embodiment of the present invention;

FIG. 7 is the second diagram of the pixel polarity distribution of a preferred embodiment of the present invention; and

FIG. 8 is the third diagram of the pixel polarity distribution of a preferred embodiment of the present invention.

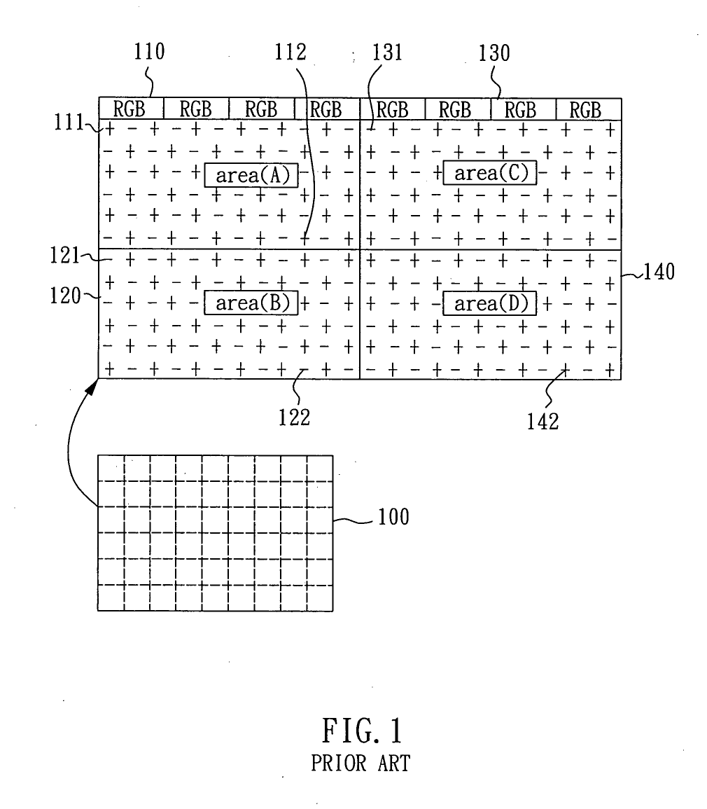

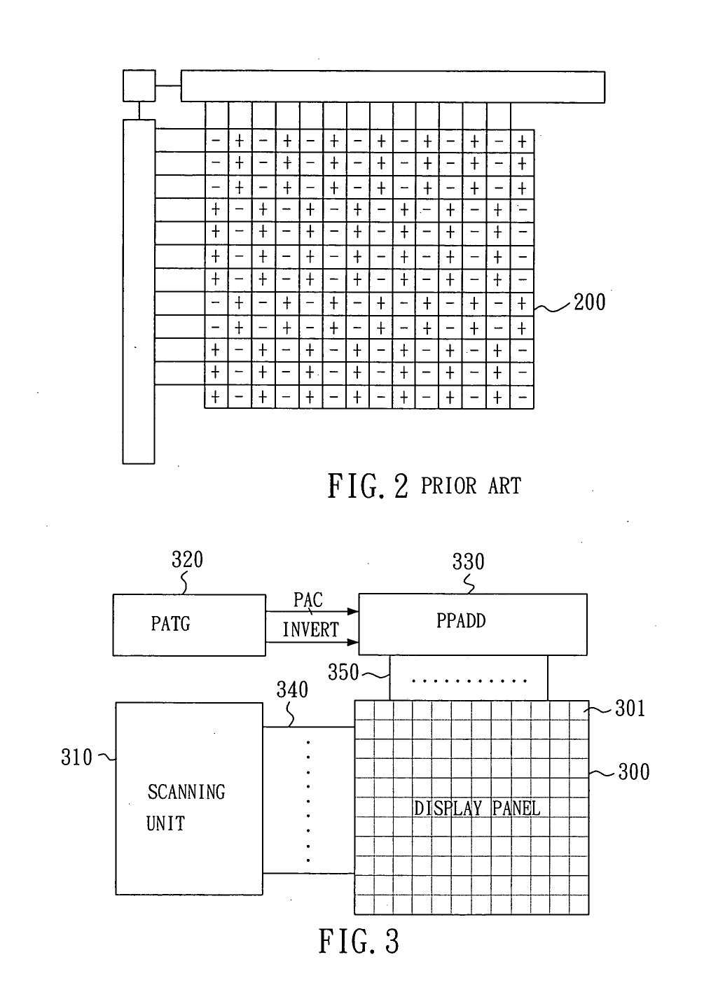

### DETAILED DESCRIPTION OF THE PREFERRED EMBODIMENTS

Referring to FIG. 3, a preferred embodiment in accordance with the present invention includes a display panel 300, a scanning unit 310, a polarity arrangement timing generator (PATG) 320 and a polarity arrangement programmable data driver (PAPDD) 330. The display panel 300 includes a plurality of pixels 301. The scanning unit 310 is connected to the display panel 300 at those pixels 301 through a plurality of scanning lines 340. The polarity arrangement programmable data driver 330 is connected to the display panel 300 at those pixels 301 through a plurality of data lines 350 for controlling the polarities of the pixels 301.

In this embodiment, the display panel 300 is preferably a LCD panel. The scanning unit 310 is preferably a gate driver. The polarity arrangement timing generator 320 is preferably a source driver or a timing controller.

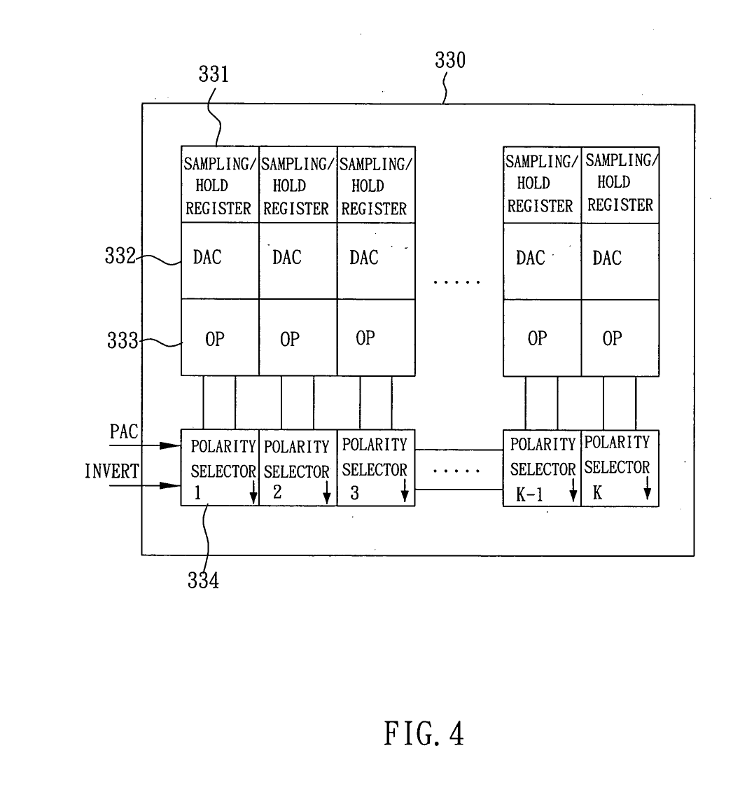

FIG. 4 illustrates the polarity arrangement programmable data driver 330 in detail. The polarity arrangement programmable data driver 330 has a plurality of sampling/hold registers 331, a plurality of D/A converters 332, a plurality of operational amplifiers 333 and a plurality of polarity selectors 334. The output of the sampling/hold registers 331 are connected to the input of the D/A converters 332, the output of the D/A converters 332 are connected to the input of the operational amplifiers 333. The outputs of the operational amplifiers 333 are connected to the inputs of the polarity selectors 334. The polarity arrangement programmable data driver 330 uses the sampling/hold registers 331 to latch the digital signals that will be sent to the pixels 301 through the data lines 350. The D/A converters 332 convert the digital signals into analog signals of positive or negative polarities, which are further enhanced by the operational amplifiers 333 for output. Before output, the polarities of the enhanced analog signals are chosen according to polarity arrangement control signals sent from the polarity arrangement timing generator 320. Thereby, an aperiodic polarity order of the output polarity distribution is formed. The polarity selectors 334 have a plurality of combinatorial states. The polarity selectors 334 in different combinatorial states correspond to different polarity selecting patterns. In this embodiment, a preferred number of combinatorial states are sixteen.

Alternatively, the inputs of the polarity selectors 334 can be directly connected to the outputs of the D/A converters 332, so that the polarities of the output signals are pre-selected according to polarity arrangement control signals. The output signals are then enhanced by corresponding operational amplifiers 333 and sent to the display panel 300 in an aperiodic polarity order.

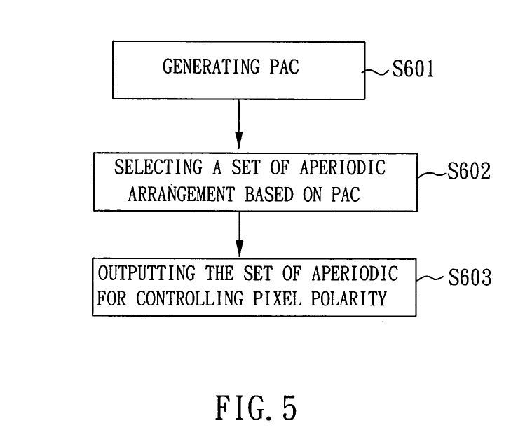

Referring to FIGS. 3, 4, and 5, the control of polarities of pixels 301 is illustrated. The polarity arrangement timing generator 320 firstly produces multiple bits of polarity arrangement control signals, which are then output to the polarity arrangement programmable data driver 330 (Step S601). After receiving the polarity arrangement control signals, the polarity arrangement programmable data driver 330 selects one of the polarities (i.e., positive polarity or negative polarity) from the operational amplifiers 333 for output based on those control signals. The output signals after polarity selection, being sent to the display panel 300, form an aperiodic polarity order. As to a frame, the polarity arrangement programmable data driver 330 outputs a plurality of aperiodic polarity orders to the display panel 300. Those aperiodic polarity orders are different every time the polarity arrangement programmable data driver 330 outputs, which is determined by the polarity arrangement control signals produced every time by the polarity arrangement timing generator for polarity arrangement control 320. (Step S602)

Therefore, the pixels 301 of the display panel 300 have a polarity distribution based on the matrix formed by the aperiodic polarity orders. The polarity arrangement timing generator for polarity arrangement control 320 and the polarity arrangement programmable data driver 330 controls a plurality of frames shown on the display panel 300 for a given time period, during which half of the frames are complementary to the other half in terms of polarity. For example, if 240 frames are shown in 10 seconds, the polarity distribution of 120 frames is complementary to that of the other 120 frames in terms of polarity. That is, the pixels 301 of the first frame are supplied with voltage signals having polarities exactly opposite to those signals supplied to one of frames from the second to the 240th. It is a further requirement that the entire polarity inversion between adjacent frames can be avoided for saving electric power. (Step S603)

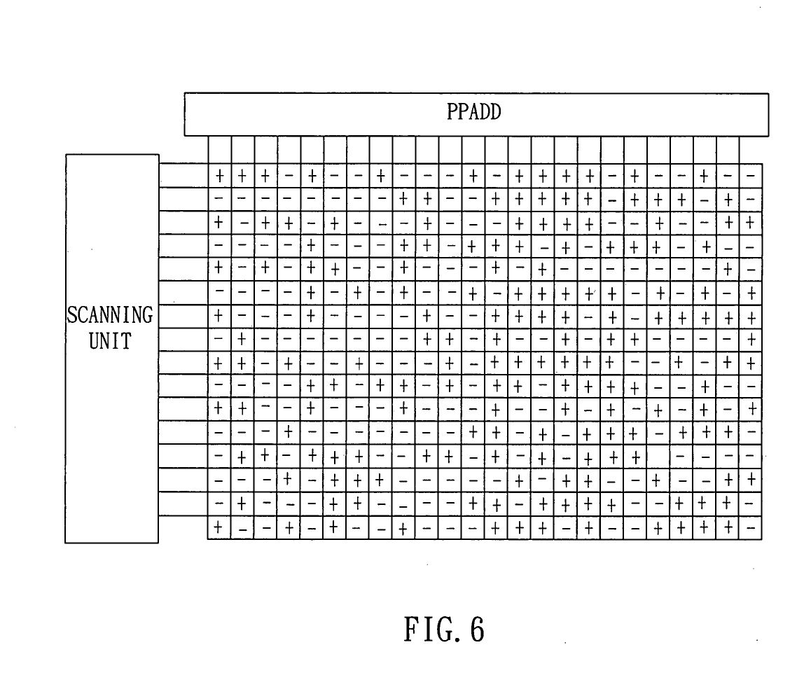

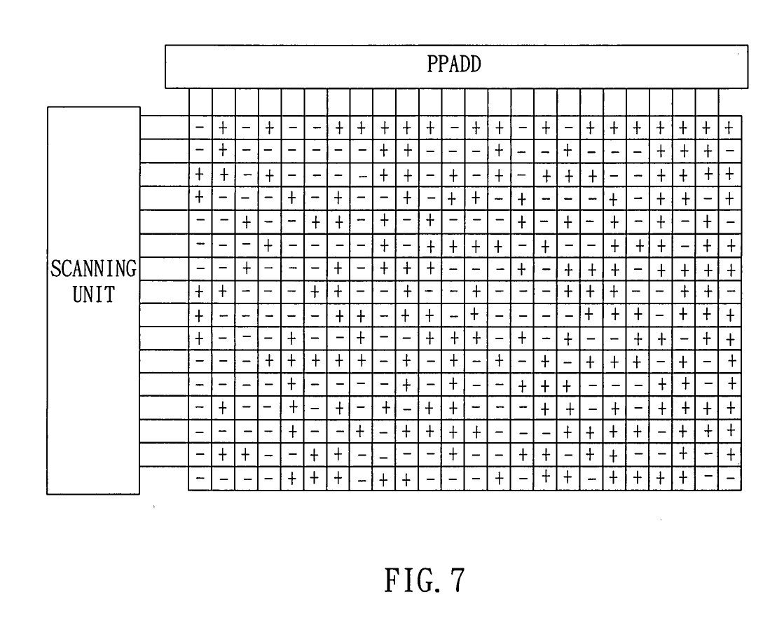

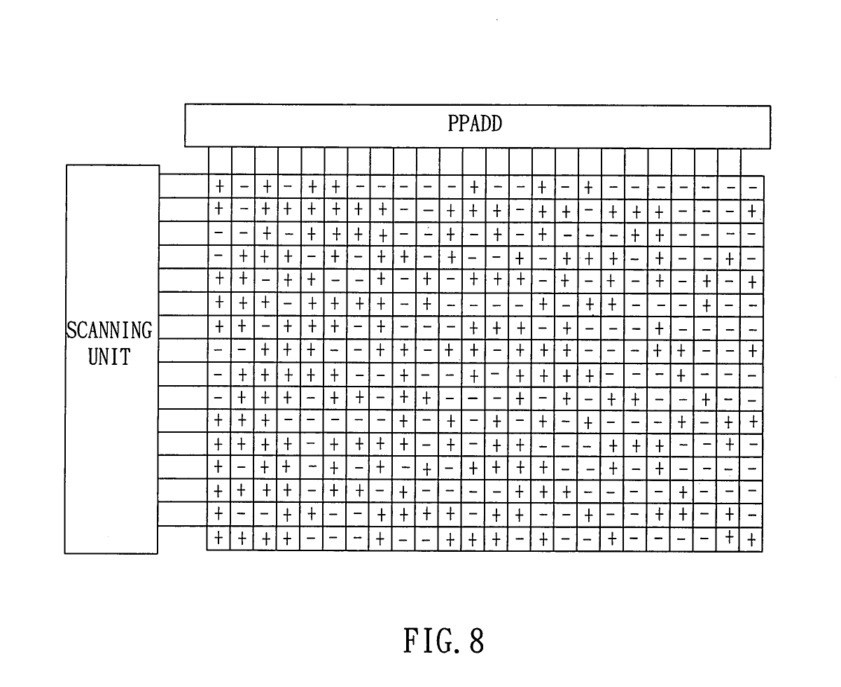

Referring FIGS. 6, 7, and 8, the polarity distribution of the pixels 301 on the display panel 300 is illustrated, in which the polarity variations either along a row or along a column are aperiodic, thereby reducing the effect of “crosstalk” and thus enhancing the image quality.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A liquid crystal display comprising:
a display panel having a plurality of pixels;
a scanning unit connected to the display panel by a plurality of scanning lines so that the scanning unit controls the pixels of the display panel via the scanning lines;
a polarity arrangement timing generator (PATG) for generating a plurality of polarity arrangement control (PAC) signals; and
a polarity arrangement programmable data driver (PAPDD) connected to a plurality of data lines and receiving the polarity arrangement control signal so as to output a set of aperiodic polarity order to the data lines so that the polarities of the pixels are distributed aperiodically.

2. The liquid crystal display of claim 1, wherein the polarity arrangement programmable data driver further includes a plurality of sampling/hold registers for latching digital signals sent to the pixels of the display panel.

3. The liquid crystal display of claim 1, wherein the polarity arrangement programmable data driver further includes a plurality of sampling/hold registers, a plurality of digital/analog (D/A) converters, a plurality of operational amplifiers and a plurality of polarity selectors, the output of the sampling/hold registers being connected to the input of the D/A converters, the output of the D/A converters being connected to the input of the operational amplifiers so that the polarity selectors select the output signals from the operational amplifiers according to the polarity arrangement control signals, and then output the selected signal to the pixels.

4. The liquid crystal display of claim 3, wherein polarities of the signals from the operational amplifiers are either positive or negative.

5. The liquid crystal display of claim 1, wherein the polarity arrangement programmable data driver further includes a plurality of sampling/hold registers, a plurality of D/A converters, a plurality of polarity selectors and a plurality of operational amplifiers, the output of the sampling/hold registers being connected to the input of the D/A converters and the output of the D/A converters being connected to the input of the polarity selectors so that the polarity selectors select the output signals from the D/A converters according to the polarity arrangement control signals, and then output the selected signal to the data lines through the operational amplifiers.

6. The liquid crystal display of claim 1, wherein, when the display panel displays a plurality frames, the polarity arrangement timing generator and the polarity arrangement programmable data driver control the polarity of the half of the frames opposite to the polarity of the other half of the frames.

7. The liquid crystal display of claim 1, wherein the display panel is a liquid crystal display panel.

8. A liquid crystal display driving method for controlling the polarity of a display panel that has a plurality of pixels, the method comprising:
a timing generation step for generating a plurality of polarity arrangement control (PAC) signals;
a selecting step for outputting a set of aperiodic polarity order based on the polarity arrangement control signals; and
a polarity controlling step for sending the set of aperiodic polarity order to the display panel and thereby controlling polarities of the pixels of the display panel such that an aperiodic polarity distribution is exhibited, wherein, when the display panel displays a plurality of frames, a pre-determined number of picture frames are displayed in a way that one half of the frames have pixels with polarities exactly opposite to those of the pixels in the other half.

9. The liquid crystal display driving method of claim 8, wherein the display panel is a liquid crystal display panel.
